(19) United States
(12) Patent Application Publication
(10) Pub. No.: US 2026/0038122 A1
(43) Pub. Date: Feb. 5, 2026

(54) SEMANTIC SEGMENTATION USING LANGUAGE MODEL SUPERVISION

(71) Applicant: Cisco Technology, Inc., San Jose, CA (US)

(72) Inventors: Yingjun Du, Amsterdam (NL); Gaowen Liu, Naperville, IL (US); Yuguang Yao, East Lansing, MI (US); Charles Fleming, Oxford, MS (US); Ramana Rao V.R. Kompella, Foster City, CA (US)

(73) Assignee: Cisco Technology, Inc., San Jose, CA (US)

(21) Appl. No.: 18/790,114

(22) Filed: Jul. 31, 2024

(51) Int. Cl. G06T 7/11; G06V 10/764; G06V 20/52

(52) U.S. Cl. CPC G06T 7/11; G06V 10/764; G06V 20/52

(57) ABSTRACT

In one implementation, a device receives a superclass and an image specified via a user interface. The device identifies subclasses of the superclass using a language model. The device generates, for each of the subclasses, subclass image masks for the image. The device forms an ensemble segmentation mask for the image based on the subclass image masks that represents the superclass.

### TECHNICAL FIELD

The present disclosure relates generally to computer networks, and, more particularly, to semantic segmentation using language model supervision.

### BACKGROUND

With the advents of machine and deep learning, video analytics systems have grown in both their capabilities, as well as their complexities. One use for such systems exists in the context of multi-camera surveillance systems, to detect people and other objects and make decisions about their behaviors. For instance, a surveillance system in an airport or other sensitive area may seek to detect when a person leaves an object unattended.

Semantic segmentation is a computer vision technique that seeks to assign textual labels to each pixel of an image. For example, such an approach may label an image as depicting a vehicle, a pedestrian, a crosswalk, etc. This plays a crucial role in computer vision, and enables higher level tasks, such as identifying or predicting hazardous events, performing person or object reidentification across different video streams, and the like.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example system for performing video analytics;

FIG. 4 illustrates an example architecture for performing semantic segmentation using language model supervision;

FIG. 5 illustrates an example user interface for the architecture in FIG. 4; and

FIG. 6 illustrates an example simplified procedure for performing semantic segmentation using language model supervision.

### DESCRIPTION OF EXAMPLE IMPLEMENTATIONS

### Overview

According to one or more implementations of the disclosure, a device receives a superclass and an image specified via a user interface. The device identifies subclasses of the superclass using a language model. The device generates, for each of the subclasses, subclass image masks for the image. The device forms an ensemble segmentation mask for the image based on the subclass image masks that represents the superclass.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

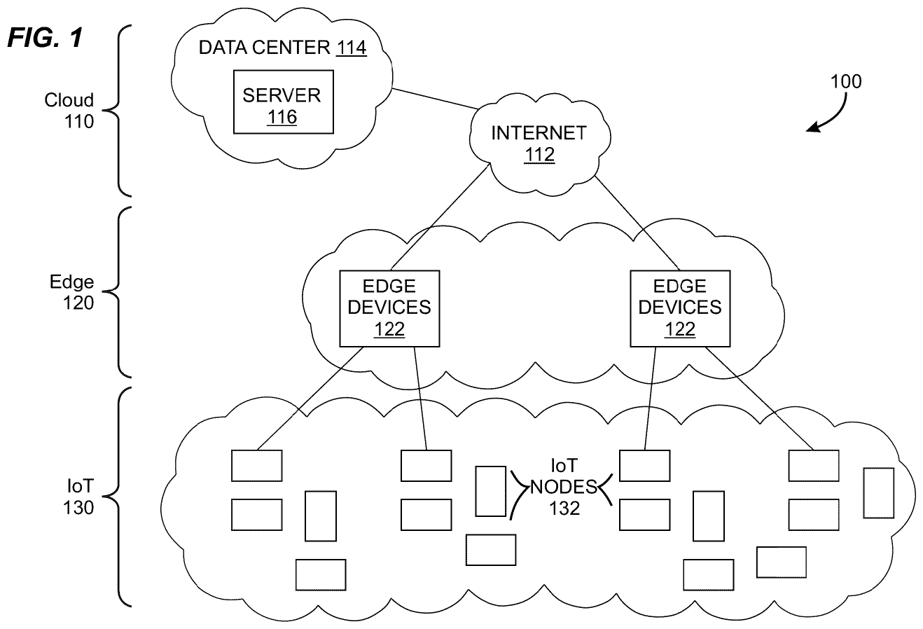

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.,), or other shared-media protocols where appropriate. In this context, a protocol consists of a set of rules defining how the nodes interact with each other.

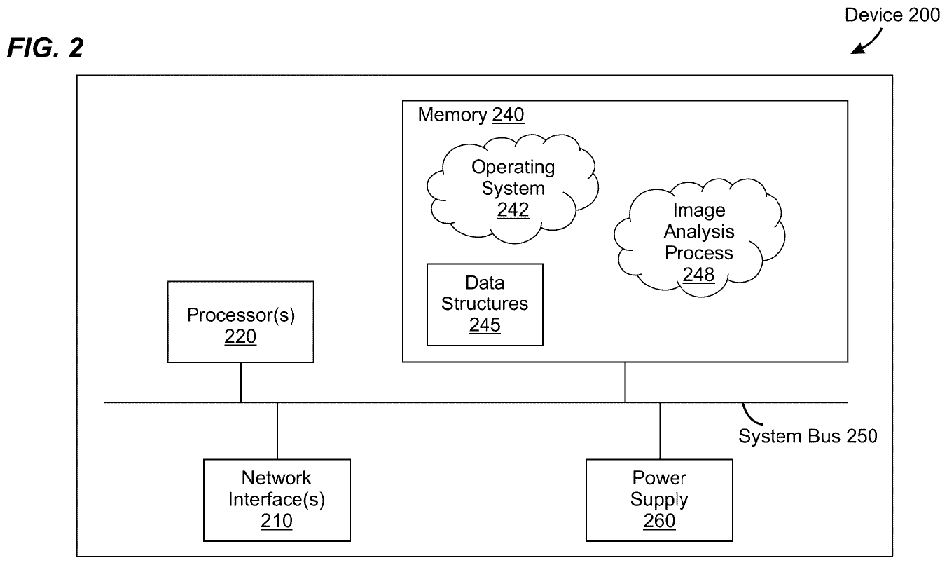

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative image analysis process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, image analysis process 248 may employ one or more supervised, unsupervised, or self-supervised machine learning models. Generally, supervised learning entails the use of a training set of data that is used to train the model to apply labels to the input data. For example, the training data may include sample video data depicting a particular event that has been labeled as such. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Self-supervised learning models take a middle ground approach that uses a greatly reduced set of labeled training data.

Example machine learning techniques that image analysis process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further implementations, image analysis process 248 may also leverage one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

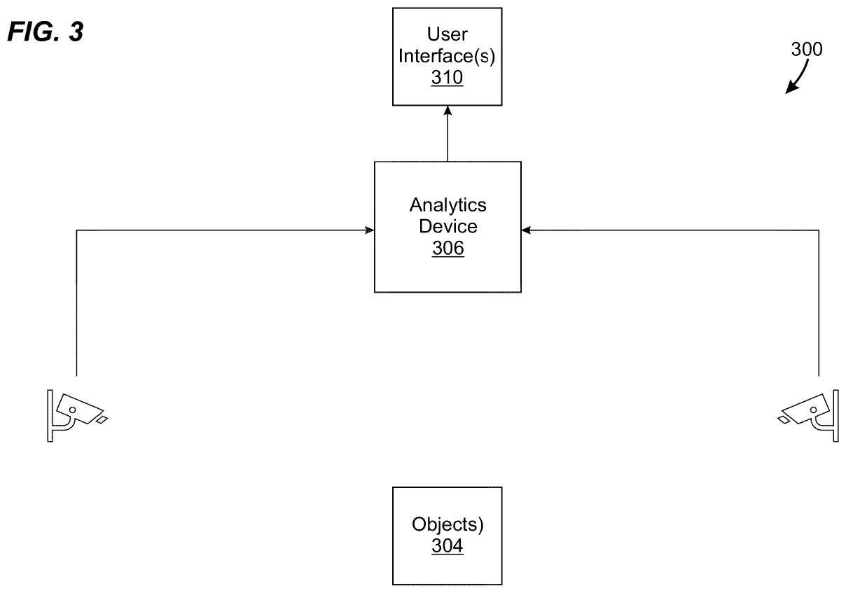

FIG. 3 illustrates an example system 300 for performing video analytics, as described in greater detail above. As shown, there may be any number of cameras 302 deployed to a physical area, such as cameras 302a-302b. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, cameras 302a-302b may generate and send video data 308a-308b, respectively, to an analytics device 306 (e.g., a device 200 executing image analysis process 248 in FIG. 2). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, a particular camera 302, or the lie.

In general, analytics device 306 may be configured to provide video data 308a-308b for display to one or more user interfaces 310, as well as to analyze the video data for events that may be of interest to a potential user. To this end, analytics device 306 may perform object detection on video data 308a-308b, to detect and track any number of objects 304 present in the physical area and depicted in the video data 308a-308b. In some implementations, analytics device 306 may also perform object re-identification on video data 308a-308b, allowing it to recognize an object 304 in video data 308a as being the same object in video data 308b or vice-versa.

As noted above, machine and deep learning techniques now allow for the identification of different objects, events, and the like that are represented in an image, such as one captured by system 300. One popular approach to do so is semantic segmentation, which seeks to classify each pixel in an image. Such identification can drive alerts (e.g., the presence of unattended luggage in a secure area, etc.), predictions (e.g., predicting an accident before it happens based on the movement of objects over time, etc.), and the like.

However, configuring a model to perform semantic segmentation typically requires significant training using a large training dataset that includes images that have been labeled accordingly. Once trained, it also becomes quite difficult to retrain the model to identify new classes or sub-classes without requiring a new training dataset reflective of the new labels.

### ——Semantic Segmentation Using Language Model Supervision——

The techniques herein allow for the performance of semantic segmentation in a training-free manner. In some aspects, the techniques herein do so using a language model, such as a large language model (LLM) to generate labels, such as those for sub-classes of a superclass label. In further aspects, a user interface is also introduced herein that allows an administrator to control the functioning of the segmentation system.

Illustratively, the techniques described herein may be performed by hardware, software, and/or firmware, such as in accordance with the image analysis process 248, which may include computer executable instructions executed by the processor 220 (or independent processor of interfaces 210), to perform functions relating to the techniques described herein.

Specifically, according to various implementations, a device receives a superclass and an image specified via a user interface. The device identifies subclasses of the superclass using a language model. The device generates, for each of the subclasses, subclass image masks for the image. The device forms an ensemble segmentation mask for the image based on the subclass image masks that represents the superclass.

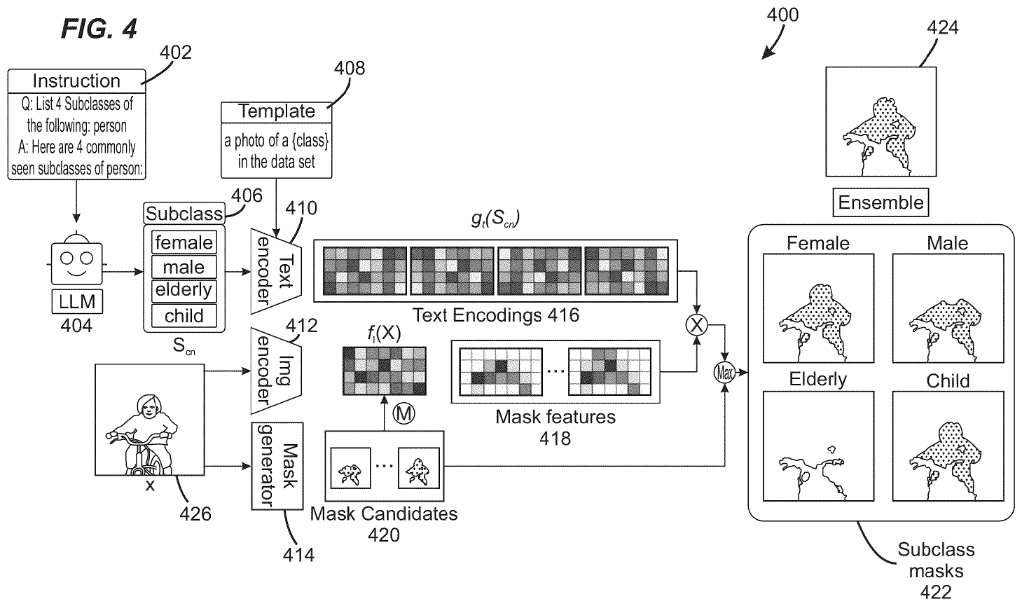

Operationally, in various implementations, FIG. 4 illustrates an example architecture 400 for performing semantic segmentation using language model supervision. In various implementations, image analysis process 248 may be implemented using architecture 400. As shown, image analysis process 248 may perform training-free segmentation via supervision by a language model, such as LLM 404.

In various implementations, a user may interact with architecture 400 via a user interface. For instance, the user may provide a textual instruction 402 and an input image 426 on which architecture 400 is to perform segmentation. In some implementations, instruction 402 may indicate one or more superclass labels for which architecture 400 is to use for the segmentation. Here, each superclass label, denoted as c, represents a specific concept in natural language, e.g., “person.”

In various implementations, architecture 400 may pass textual instruction 402 to LLM 404 asking it to identify a number of subclass labels 406 of the superclass label(s). In some instances, textual instruction 402 may also specify a particular number of subclass labels that LLM 404 is to identify. For instance, in the case of the superclass label being “person,” LLM 404 may generate a corresponding set of subclass labels Sen, such as {“female,” “male,” “elderly,” and “child”}, where c, is the nth subclass name of superclass c. As would be appreciated, LLM 404 may take the form of any LLM or other language model capable of identifying the subclasses of a specified superclass. In addition, image analysis process 248 when implementing architecture 400 may make use a local LLM 404 or, alternatively, access it remotely, such as via an application programming interface (API).

In various implementations, architecture 400 may also include a text encoder 410 that takes as input subclass labels 406. As shown, text encoder 410 may use a set of templates, such as template 408, to form text encodings 416 based on the subclass labels 406. For instance, template 408 may take the form of a photo of a given class or subclass in the dataset. In general, the features of the generated subclass may be represented as:

$${g}_{T} ( {S}_{cn} ) ∈ {ℝ}^{n \times {m}_{t} \times d}$$

In addition, architecture 400 may also include an image encoder 412 which receives as input a test image X (e.g., test image 426). In doing so, image encoder 412 extracts the image features from input image 426 represented as:

$${f}_{I} ( X ) ∈ {ℝ}^{{m}_{i} \times d}$$

Architecture 400 may further include a mask generator 414 that also takes as input image 426 to generate mask candidates 420. As would be appreciated, mask generator 414 may use any number of different mask extraction/segmentation techniques, to do so. By explicitly utilizing these mask proposals, architecture 400 is capable of handling intricate instance level segmentation masks in conjunction with a contrastive language-image pretraining (CLIP) model.

More specifically, for each of the mask candidates 420, architecture 400 may extract the global context visual features using the pre-trained CLIP model. It is also worth noting that the original visual features derived from CLIP are designed to generate a single feature vector that describes the entire image. To address this limitation, image encoder 412 may take the form of a visual encoder derived from CLIP to capture features that incorporate information not only from the masked area but also from the surrounding regions, enabling a deeper understanding of relationships between multiple objects. Such features 418 may be of the form:

$${f}_{m} = {f}_{I} ( X ) ⊙ \overline{m}$$

where m̅ is the resized mask scaled to the size of the feature map, and ⊙ is a Hadamard product operation. Subsequently, architecture 400 may determine the resemblance between global-context visual feature fₘ and subclass text features g_{T}(S_{cn}), to derive the attention weight A. This weight may play an important role in the ensemble phase. The calculation of the attention weight A is executed as follows:

$$A ∈ {ℝ}^{n \times {m}_{i}} = [ {f}_{m} ] \times [ {g}_{T} ( {S}_{cn} ) ]$$

Architecture 400 may then identify the highest value within the matrix A to indicate the choice of mask among the available candidates for a particular subclass name, thereby selecting subclass masks 422 for each of the subclass labels 406 identified by LLM 404. In some implementations, architecture 400 may also refine the masks using up-sampling and/or a conditional random field (CRF) for greater accuracy.

Subsequently, after obtaining the mask for each subclass, architecture 400 may combine them to make a final mask prediction 424. More specifically, architecture 400 may employ an ensemble process that assigns weights to each subclass first by considering the similarity between the textual feature and image feature of a subclass and then applying a SoftMax function, to determine these weights.

As would be appreciated, various use cases are possible for the deployment of architecture 400. For instance, architecture 400 may be used to generate segmentation masks in cases in which different objects appear in different scenes or when subclasses differ according to different scenes. In some instances, as detailed below, a user may also set different weights for different subclass categories, to further improve the segmentation results, as well.

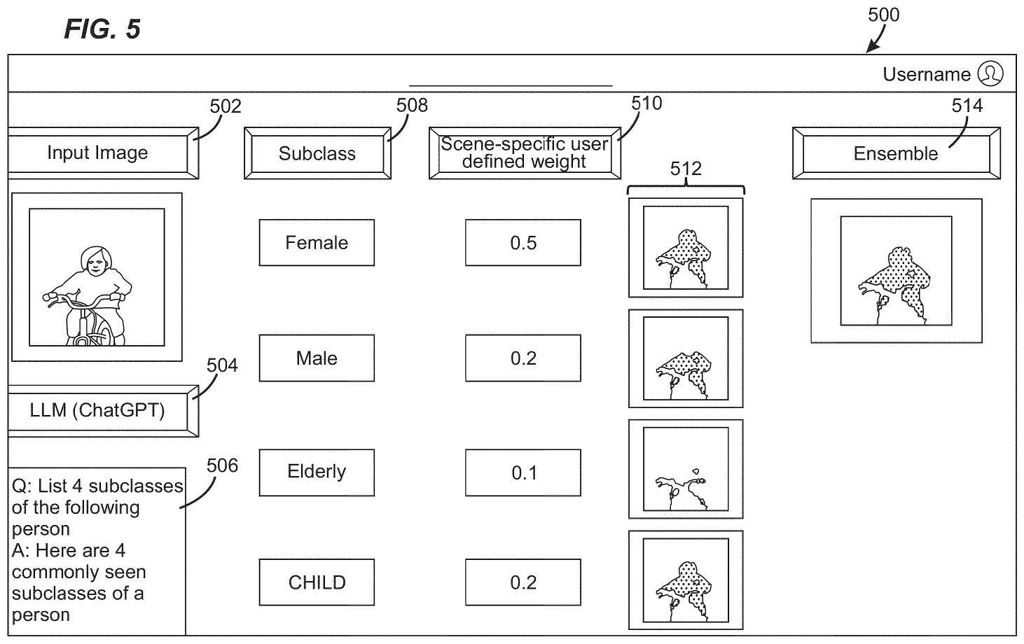

FIG. 5 illustrates an example user interface 500 for the architecture in FIG. 4, in some implementations. As shown, user interface 500 may include an input option 502 that allows the user to select an input image for segmentation. User interface 500 may also include an option 504 that allows the user to select the specific LLM or other language model that the system uses to identify the subclasses. In some instances, user interface 500 may include a chat portion 506 that allows the user to interact with the selected LLM or other language model. For instance, the user may issue the query “List 4 subclasses of the following person,” to which the model may answer “Here are 4 commonly seen subclasses of a person.” At portion 508, user interface 500 may display the identified subclasses.

In some implementations, user interface 500 may also include inputs 510 that allow the user to specify the weights for each subclass with respect to the specific scene depicted in the selected image. In other cases, the system may use default or automatically selected weights. In turn, user interface 500 may return the best segmentation masks 512 for each of the subclasses. Further, user interface 500 may return an ensemble mask 514 that combine the best segmentation masks 512 generated by the system.

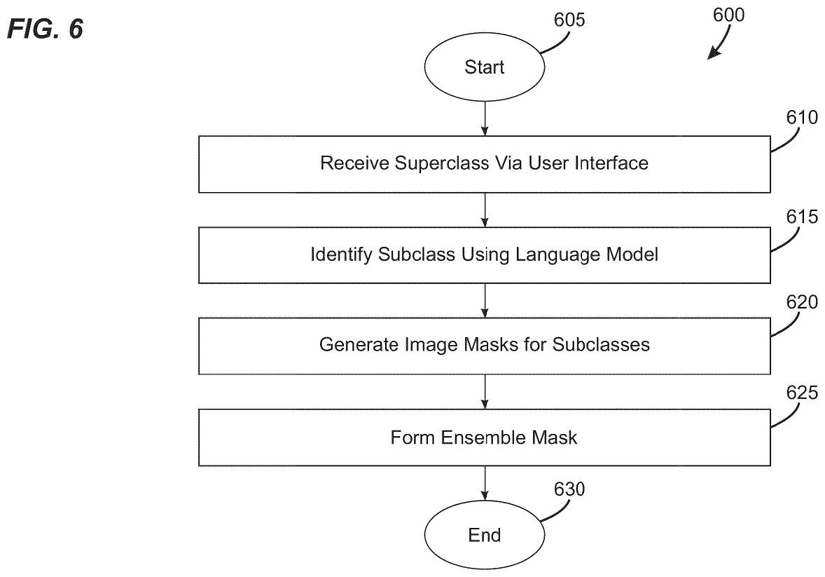

FIG. 6 illustrates an example simplified procedure 600 (e.g., a method) for performing semantic segmentation using language model supervision, in accordance with one or more implementations described herein. For example, a non-generic, specifically configured device (e.g., device 200), such as an edge device, a server, or other device in a network, may perform procedure 600 by executing stored instructions (e.g., image analysis process 248). The procedure 600 may start at step 605, and continues to step 610, where, as described in greater detail above, the device may receive a superclass and an image specified via a user interface. In some cases, the image was captured by a video surveillance system.

At step 615, as detailed above, the device may identify subclasses of the superclass using a language model. In various implementations, the language model is a large language model (LLM). In further implementations, the device may use a text encoder to form text encodings of the subclasses. In one implementation, the text encoder forms the text encodings using a template image.

At step 620, the device may generate, for each of the subclasses, subclass image masks for the image, as described in greater detail above. In various implementations, the device may do so by combining text encodings of the subclasses with mask features of candidate masks for the image.

At step 625, as detailed above, the device may form an ensemble segmentation mask for the image based on the subclass image masks that represents the superclass. In some implementations, the device may also provide an indication of the ensemble segmentation mask to the user interface. In further implementations, the device may cause the ensemble segmentation mask to be used to classify a second image. In one implementation, the device may form the ensemble segmentation mask based in part on attention weights associated with the subclasses. In some cases, the device receives the attention weights via the user interface.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for performing semantic segmentation using language model supervision, it is to be understood that various other adaptations and modifications may be made within the spirit and scope of the implementations herein. For example, while certain implementations are described herein with respect to specific use cases for the techniques herein, the techniques can be extended without undue experimentation to other use cases, as well.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
receiving, at a device, a superclass and an image specified via a user interface;
identifying, by the device, subclasses of the superclass using a language model;
generating, by the device and for each of the subclasses, subclass image masks for the image;
forming, by the device, an ensemble segmentation mask for the image based on the subclass image masks that represents the superclass.

2. The method as in claim 1, further comprising:
providing, by the device, an indication of the ensemble segmentation mask to the user interface.

3. The method as in claim 1, further comprising:
causing, by the device, the ensemble segmentation mask to be used to classify a second image.

4. The method as in claim 1, wherein the language model is a large language model (LLM).

5. The method as in claim 1, wherein generating the subclass image masks further comprises:
combining text encodings of the subclasses with mask features of candidate masks for the image.

6. The method as in claim 1, further comprising:
using, by the device, a text encoder to form text encodings of the subclasses.

7. The method as in claim 6, wherein the text encoder forms the text encodings using a template image.

8. The method as in claim 1, wherein the image was captured by a video surveillance system.

9. The method as in claim 1, wherein the device forms the ensemble segmentation mask based in part on attention weights associated with the subclasses.

10. The method as in claim 9, further comprising:
receiving, via the user interface, the attention weights.

11. An apparatus, comprising:
a network interface to communicate with a computer network;
a processor coupled to the network interface and configured to execute one or more processes; and
a memory configured to store a process that is executed by the processor, the process when executed configured to:
receive a superclass and an image specified via a user interface;
identify subclasses of the superclass using a language model;
generate, for each of the subclasses, subclass image masks for the image;
form an ensemble segmentation mask for the image based on the subclass image masks that represents the superclass.

12. The apparatus as in claim 11, wherein the process when executed is further configured to:
provide an indication of the ensemble segmentation mask to the user interface.

13. The apparatus as in claim 11, wherein the process when executed is further configured to:
cause the ensemble segmentation mask to be used to classify a second image.

14. The apparatus as in claim 11, wherein the language model is a large language model (LLM).

15. The apparatus as in claim 11, wherein the apparatus generates the subclass image masks further by:
combining text encodings of the subclasses with mask features of candidate masks for the image.

16. The apparatus as in claim 11, wherein the process when executed is further configured to:
use a text encoder to form text encodings of the subclasses.

17. The apparatus as in claim 16, wherein the text encoder forms the text encodings using a template image.

18. The apparatus as in claim 11, wherein the image was captured by a video surveillance system.

19. The apparatus as in claim 11, wherein the apparatus forms the ensemble segmentation mask based in part on attention weights associated with the subclasses.

20. A tangible, non-transitory, computer-readable medium storing program instructions that cause a device to execute a process comprising:
receiving, at the device, a superclass and an image specified via a user interface;
identifying, by the device, subclasses of the superclass using a language model;
generating, by the device and for each of the subclasses, subclass image masks for the image;
forming, by the device, an ensemble segmentation mask for the image based on the subclass image masks that represents the superclass.
